(19) United States
(12) Patent Application Publication
(10) Pub. No.: US 2010/0040886 A1
(43) Pub. Date: Feb. 18, 2010

(54) GRANULATION AND STABILIZATION OF RESIN SYSTEMS FOR USE IN THE PRODUCTION OF FIBER COMPOSITE COMPONENTS

(75) Inventors: Han LUINGE, Muenchen (DE); Olivier MEYER, Ottobrunn (DE)

Correspondence Address: YOUNG & THOMPSON, 209 Madison Street, Suite 500, Alexandria, VA, 22314, US

(73) Assignee: EUROCOPTER DEUTSCHLAND GmbH, Donauworth (DE)

(21) Appl. No.: 12/542,319

(22) Filed: Aug. 17, 2009

(30) Foreign Application Priority Data
Aug. 18, 2008 (DE) 10 2008 038 295.7

(51) Int. Cl. B32B 15/092; C08J 3/02; C09J 163/00

(52) U.S. Cl. 428/407; 264/7; 156/330

(57) ABSTRACT

This invention relates quite in general to production of fiber composite components by infiltration of a fiber material with a synthetic resin and subsequent curing. In order to improve the required preparation of a liquid or viscous resin system, as claimed in the invention especially a synthetic resin granulate (10, 12) and a process for its production are provided, encompassing the step of stabilization of the synthetic resin granulate (10′) by adding nanoparticles (12′) which attach on the surface of the granulate particles (10). The granulate (10, 12) which is thus free of blocks can be easily handled, for example bagged, flow-conveyed and metered. Advantageously the nanoparticles do not have an adverse effect on the infiltration properties of the resin and on the component properties.

This invention relates quite generally to production of fiber composite components as are of interest mainly due to their high specific strength (ratio of strength to weight) in many applications.

A fiber composite material is a mixed material which generally consists of two main components, specifically a matrix and fibers embedded in it. The matrix is generally a thermally settable synthetic resin, optionally with special additives (“resin system”).

In particular, the invention relates to making available a resin system for infiltration of a fiber material within the framework of producing fiber composite components.

In known processes for producing fiber composite components using a resin infiltration process, a synthetic resin which is stored preferably in solid form with respect to stability must be melted and metered in order to supply it in a well defined amount to the infiltration process.

Typical storage temperatures of synthetic resin material of the type of interest here are often less than 0° C., especially in order to prevent unwanted premature crosslinking and to prolong stability. Since the synthetic resin should not be repeatedly heated (liquefied), because this causes it to lose quality, the known methods of melting a synthetic resin body stored at low temperature are problematic. This also applies when the synthetic resin is only partially melted.

The object of this invention is to eliminate the above explained problems in order to improve the production of fiber composite components with respect to making available a liquid or viscous resin system.

This object is achieved as claimed in the invention essentially by a process of producing a synthetic resin granulate as claimed in claim 1 and a synthetic resin granulate which has been produced using this process. The dependent claims relate to advantageous developments of the invention.

According to a first aspect of the invention, a process is provided for producing a synthetic resin granulate for use for a resin infiltration process in the production of a fiber composite component, comprising the step of stabilization of the synthetic resin granulate by adding nanoparticles.

This granulate, consisting for example of granulate particles with dimensions in the millimeter range or even in the centimeter range, can be easily handled, for example, bagged, flow-conveyed, and metered. Therefore it can be supplied especially to a resin infiltration process in a well defined amount. Stabilization (absence of blocks) of the granulate is accomplished in this connection by adding nanoparticles which are attached on or in the surface of the granulate particles and thus act as a separating agent. Advantageously the nanoparticles do not have an adverse effect on the infiltration properties of the resin and on the component properties.

The invention makes it possible to meter the resin in the frozen state as a granulate. In this way repeated heating of the material can be avoided. Granulation and stabilization can be provided for example directly in the production of the resin or as a last step of this production. The synthetic resin granulate which is suitable for use for a resin infiltration system (for example fragments with moderate expansion in the range of roughly 1-2 cm) can be for example bagged and stored in this form.

The addition of nanoparticles for stabilization of the granulate is of critical importance in practice. Resin systems of the type of interest here after conventional granulation would often yield a granulate which tends to stick together or agglomerate in the frozen state (storage state) as well.

Still the granulation provided in the invention can as such be advantageously managed according to known methods or using known “granulators”. Only a so-called strand granulator will be mentioned here by way of example; it is used in the field of plastics technology for comminuting thermoplastic strands. This device operates like many other granulator designs based on mechanical comminution of a larger piece of material by cutting, grinding, chipping, etc.

With respect to the temperature sensitivity of many synthetic resins commonly used in fiber composite production, so-called “freezing granulation processes” are especially of interest, in which the granulator used or the material which is processed with it is actively cooled. Moreover many of the synthetic resins of interest here acquire the strength necessary for mechanical comminution by cutting only at temperatures less than 0° C., especially for example at roughly or less than −10° C.

Preferably the synthetic resin is processed with a standard method as is known for example from food technology (for example, for spinach or sauces) into a frozen granulate and then stabilized with nanoparticles. The nanoparticles which attach on the surface of the granulate particles ensure that the granulate remains free of blocks.

The nanoparticles can be added as powders. In particular, addition can take place directly at the discharge site of the granulator used at which a granulate particle stream leaves the granulate. According to one development, the nanoparticles are added in the discharge passage of the granulator, for example injected by means of a (for example cooled) air flow, and by the motion of the individual granulate particles in this discharge passage and/or active mixing or swirling in this discharge passage they are uniformly distributed. Thus a correspondingly uniform distribution of nanoparticles on the granulate surface or in the layer of granulate material near the surface can be achieved.

For the resin system to be used in the invention, known synthetic resin compositions can be advantageously used. In particular an epoxy resin, polyester resin or phenolic resin are possible.

The invention is of interest mainly for hot-setting synthetic resins whose gelling noticeably begins at room temperature or at temperatures somewhat above it. One example of this is the synthetic resin sold under the trade name “RTM6” in which it is an epoxy resin system whose stability at room temperature is limited to roughly two weeks and which gels at a temperature of 140° C. in less than two hours.

The nanoparticles used can be especially at least roughly spherical nanoparticles, for example with an average diameter in the range of roughly 5 to 50 nm, furthermore preferably in the range from roughly 10 nm to 20 nm.

It has been ascertained that a comparatively small number of nanoparticles is sufficient to achieve the advantage of absence of blocks. In one embodiment it is accordingly provided that the nanoparticles are added in an amount from roughly 0.01 to 1% by weight.

The nanoparticles can consist for example of carbon, a metal oxide, a semiconductor or a metal. In one preferred embodiment it is provided that metal oxide nanoparticles are added. Good results were achieved for example with a powder of silicate nanoparticles (for example, nanoparticle powders based on amorphous silicon dioxide sold under the trade name “Aerosil”).

The granulate particles produced in the process preferably have maximum expansion in the range from 1 mm to 30 mm, furthermore preferably in the range from 5 mm to 20 mm and are preferably placed in storage containers (for example bags) directly after their stabilization by the nanoparticles.

According to a second aspect of the invention, the synthetic resin granulate is intended for use for a resin infiltration process in the production of a fiber composite component, the synthetic resin granulate being produced in the manner already described above and encompassing nanoparticles on the granulate surface and/or in the layer near the surface.

With respect to the type of synthetic resin and type and number of nanoparticles, there can be the above explained particulars or special versions. In particular it can be a granulate which is produced on the basis of an epoxy resin and which is stabilized with spherical metal oxide nanoparticles with a diameter of roughly 12 nm.

Advantageously the resin granulate also retains its capacity to be metered in the frozen state (storage state). The nanoparticles are used as a separating agent and in existing studies they do not show any adverse effects on the properties of the resin with respect to its use in the production of fiber composite components.

According to a third aspect of the invention, the resin infiltration process is intended for production of a fiber composite component, comprising the step of melting of the synthetic resin granulate which is made or produced in the above described manner in order to make available an infiltration-capable, i.e. relatively liquid or viscous synthetic resin material.

For the specific configuration of the infiltration process as such, the methods known from fiber composite technology can be advantageously used. For example, the following standard methods are possible: resin transfer molding (RTM), vacuum infusion (for example VAP, VARI, etc.) and their developments (for example SLI, LRI, DP-RTM), etc.

A fiber material to be infiltrated can be placed in a suitable tool in the form of individual fiber segments during and/or as a semifinished fiber article (for example fabric, weave, braid, fiber mats, etc.) before infiltration. In this infiltration tool optionally molding and at least partially setting can also take place. In infiltration of an epoxy resin, depending on the resin composition, curing can take place thermally in the temperature range for example between room temperature and 200° C. In an infiltration and curing cycle which is conventional in the production of components in the field of aeronautics and astronautics, the actual curing takes place typically at roughly 180° C.+/−5° C. (for roughly 1.5 to 2 hours).

According to a fourth aspect of the invention, the process is intended for producing a fiber composite component, comprising a resin infiltration process of the above described type.

This process is not subject to any special limitations with respect to the type of fiber material used (for example, individual fibers, rovings, flat semifinished fiber articles, etc.) and with respect to the type of resin system used (matrix). For example carbon fibers, glass fibers, synthetic plastic resins, steel fibers or natural fibers can be provided.

In one preferred embodiment the produced fiber composite component is a structural component which can be used in automotive engineering or aeronautics and astronautics.

Reinforcing profiles (such as for example T-beams) and flat (shell-like) structural components are mentioned only by way of example.

The invention is further described below using exemplary embodiments with reference to the attached drawings.

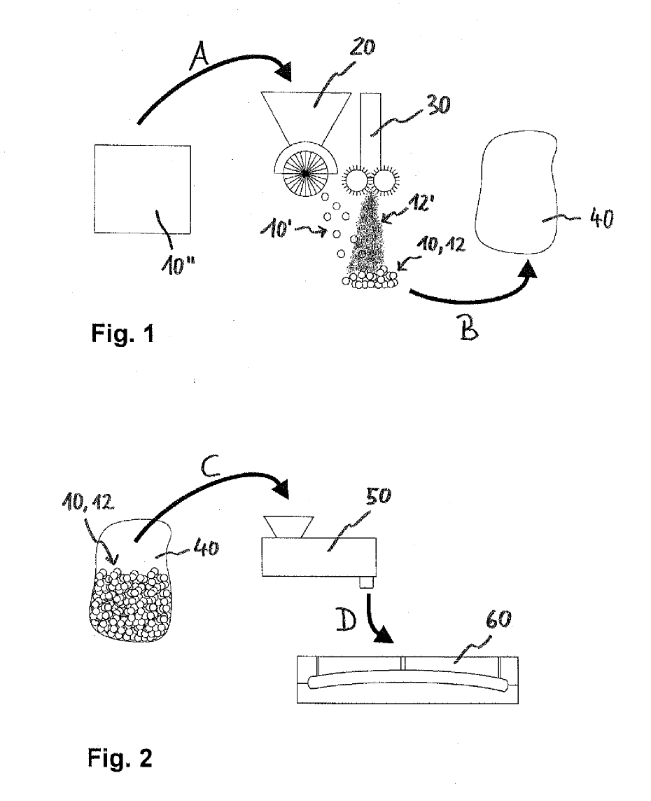

FIG. 1 shows a schematic of the production of a synthetic resin granulate, and

FIG. 2 shows a schematic of the use of a synthetic resin granulate.

FIG. 1 illustrates production and bagging of a synthetic resin granulate 10, 12.

For this purpose a larger block of material or material strand or material strand segment of 10″ of a synthetic resin is supplied to a granulator 20 (arrow A).

The granulator 20 on the discharge side delivers a granulate particle stream 10′ to which a nanoparticle stream 12′ is added by means of a powder metering means 30. By attachment of nanoparticles 12′ on the surface and/or in the boundary layer of the surface of the resin granulate 10′ a stabilized (free of blocks or easily pourable) granulate is formed consisting of synthetic resin particles 10, for example with expansion in the cm size range, and nanoparticles 12 which have superficially attached or intercalated thereon, for example with expansion of a few nm.

The synthetic resin granulate 10, 12 which has thus been stabilized is for example produced in individual portions by a conveyor means and each portion is placed in a storage container (arrow B). The storage container can be for example a storage bag 40.

The entire production and bagging process shown in FIG. 1 takes place with cooling of the processed synthetic resin 10″, 10′ or 10 whose temperature is kept below 0° C. over the entire process (for example less than 10° C.). The supplied (arrow A) and the discharged (arrow B) material has a temperature of roughly −20° C. in this embodiment.

The storage bag which has thus been filled with the granulate 10, 12 can advantageously be used as easily manageable storage units for making available synthetic resin which is required in the production of fiber composite components, especially using a resin infiltration process. Especially advantageously the granulate 10, 12 can be easily supplied as needed to the infiltration process. This application is described below with reference to FIG. 2.

In one advantageous embodiment the steps of granulation and stabilization take place directly following the production of the pertinent synthetic resin. The production of synthetic resins takes place conventionally in a liquid phase so that, in contrast to the illustrated embodiment, a freezing granulation means could also be used to which the synthetic resin is supplied in liquid form (coming directly from the production process), compaction and stabilization then taking place in a single process step. In this version the steps of formation of a solid synthetic resin (by cooling) and later melting are unnecessary.

FIG. 2 shows a storage bag 40 which has been made available for example by means of the process described in FIG. 1 containing a synthetic resin granulate 10 with nanoparticles 12 on the granulate surface.

The stabilized granulate 10, 12 is supplied in the currently required amount (metered) to an extruder 50 (arrow C) which causes melting of the synthetic resin and discharges viscous synthetic resin material.

The melting process advantageously does not adversely affect the granulate material which remains optionally in the storage bag 40.

Finally, the synthetic resin which has been discharged from the extruder 50 (or another melting device) is metered into a tool 60 (arrow D). The tool 60 can be for example a molding tool into which for example a semifinished fiber material article which is to be infiltrated with the synthetic resin (not shown) has been inserted beforehand. After infiltration with the synthetic resin, optionally molding, and curing, the desired fiber composite component (not shown) is formed in the conventional manner. This molding and optionally also curing can be carried out in the same tool 60. Alternatively at least one other tool is used for these process steps.

In summary, this invention can be advantageously used in the production of fiber composite components by infiltration of a fiber material with a synthetic resin and subsequent curing. In order to improve the required preparation of a liquid or viscous resin system, especially a synthetic resin granulate and a process for its production are provided, encompassing the step of stabilization of the synthetic resin granulate by adding nanoparticles which attach in the region of the surface of the granulate particles.

1. Process for producing a synthetic resin granulate (10, 12) for use for a resin infiltration process in the production of a fiber composite component, comprising the step of stabilization of the synthetic resin granulate (10′) by adding nanoparticles (12′).

2. Process as claimed in claim 1 for producing an epoxy resin granulate (10, 12).

3. Process as claimed in claim 1, wherein the nanoparticles (12′) are added in an amount from roughly 0.01 to 1% by weight.

4. Process as claimed in claim 1, wherein metal oxide nanoparticles (12′) are added.

5. Synthetic resin granulate (10, 12) for use for a resin infiltration process in the production of a fiber composite component, comprising nanoparticles (12) in the region of the granulate surface.

6. Synthetic resin granulate (10, 12) as claimed in claim 5, made as an epoxy resin granulate.

7. Synthetic resin granulate (10, 12) as claimed in claim 5, containing 0.01 to 1% by weight of nanoparticles (12).

8. Synthetic resin granulate (10, 12) as claimed in claim 5, containing metal oxide nanoparticles (12).

9. Resin infiltration process for producing a fiber composite component, comprises the step of melting the synthetic resin granulate (10, 12) as claimed in claim 5 for making available an infiltration-capable synthetic resin material.

10. Resin infiltration process as claimed in claim 9, made as a RTM process or as a vacuum infusion process.

11. Process for producing a fiber composite component, comprising a resin infiltration process as claimed in claim 9.

12. Process as claimed in claim 11, for producing a structural component in the field of automotive engineering or aeronautics and astronautics.

13. Process as claimed in claim 2, wherein the nanoparticles (12′) are added in an amount from roughly 0.01 to 1% by weight.

14. Synthetic resin granulate (10, 12) as claimed in claim 6, containing 0.01 to 1% by weight of nanoparticles (12).

15. Synthetic resin granulate (10, 12) as claimed in claim 6, containing metal oxide nanoparticles (12).

16. Synthetic resin granulate (10, 12) as claimed in claim 7, containing metal oxide nanoparticles (12).
